(19) United States
(12) Patent Application Publication
(10) Pub. No.: US 2021/0071019 A1
(43) Pub. Date: Mar. 11, 2021

(54) THERMAL INKJET INK COMPOSITION

(71) Applicant: HEWLETT-PACKARD DEVELOPMENT COMPANY, L.P., Spring, TX (US)

(72) Inventors: Goeun Sim, Corvallis, OR (US); Raymond Adamic, Corvallis, OR (US)

(21) Appl. No.: 16/607,782

(22) PCT Filed: Apr. 12, 2018
(86) PCT No.: PCT/US2018/027348

§ 371 Date: Oct. 24, 2019

(51) Int. Cl. C09D 11/14; C09D 11/322; C09D 11/328; C08L 1/04; C08K 5/053; C08K 5/098; C08K 5/19; C08K 9/04; B41J 11/00

(52) U.S. Cl. CPC C09D 11/14; C09D 11/322; C09D 11/328; C08L 1/04; C08K 5/053; C08K 2201/011; C08K 5/19; C08K 9/04; B41J 11/002; C08K 2201/004; C08K 5/098

(57) ABSTRACT

A thermal inkjet ink composition includes cellulose nanocrystals (CNCs). The cellulose nanocrystals are present in the thermal inkjet ink composition in an amount ranging from 0.5 wt % up to 3.5 wt %, based on a total weight of the thermal inkjet ink composition. The thermal inkjet ink composition further includes a sugar alcohol present in an amount ranging from 3 wt % up to about 8 wt % based on the total weight of the thermal inkjet ink composition, an organic salt present in an amount ranging from about 0.05 wt % to about 0.5 wt % based on the total weight of the thermal inkjet ink composition, a pigment, a polar solvent, and a balance of water.

### BACKGROUND

In addition to home and office usage, inkjet technology has been expanded to high-speed, commercial and industrial printing. Inkjet printing is a non-impact printing method that utilizes electronic signals to control and direct droplets or a stream of ink to be deposited on media. Some commercial and industrial inkjet printers utilize fixed printheads and a moving substrate web in order to achieve high speed printing. Current inkjet printing technology involves forcing the ink drops through small nozzles by thermal ejection, piezoelectric pressure or oscillation onto the surface of the media. The technology has become a popular way of recording images on various media surfaces (e.g., paper), for a number of reasons, including, low printer noise, capability of high-speed recording and multi-color recording.

### BRIEF DESCRIPTION OF THE DRAWINGS

Features of examples of the present disclosure will become apparent by reference to the following detailed description and drawings.

FIG. 1 is a flow diagram of a method of making an example of the thermal inkjet ink composition disclosed herein;

FIGS. 2A through 2C are graphs showing the color saturation of an example cyan thermal inkjet ink composition (2A), an example magenta thermal inkjet ink composition (2B), and a comparative example magenta ink composition (2C) on different media types (enhanced paper and plain paper(s)) at different fill densities;

FIGS. 3A through 3C are graphs showing the color saturation of examples of different colored thermal inkjet ink compositions disclosed herein (3A-3C) on different media types (enhanced paper and plain paper) at different fill densities; and

FIGS. 4A and 4B are black and white reproductions of originally colored photographs of a print formed with an example of a magenta thermal inkjet ink composition disclosed herein (4A) and a comparative magenta ink composition (4B).

### DETAILED DESCRIPTION

In thermal inkjet printing, the ink composition can affect both the printability of the ink and the print attributes of images that are formed with the ink. As such, ink performance, in terms of both printability and printed image attributes, may be controlled by modifying the components of the ink composition. However, adjusting an ink composition to achieve one attribute of ink performance may result in the compromise of another attribute. For example, increasing a binder amount in an ink can improve the durability of a printed image; however, an increase in binder can also deleteriously affect the printability of the ink by increasing the viscosity, which can lead to clogged nozzles in the printhead, etc. For another example, gelators may be added to an ink composition to improve optical density and/or color saturation; however, gelators can increase the solids content, which can lead to agglomerate formation (i.e., amount of precipitates that have accumulated in a printhead nozzle during a set time period), which can adversely affect print reliability and printhead nozzle health.

A single ink composition may also exhibit different print performance attributes on different types of media, due in part, to the different components within the different types of media. Print performance attributes that may vary from one media type to another may include color saturation of the printed image, dry times of the printed image, and durability of the printed image. An ink composition may form very different prints when printed, for example, on plain paper and on enhanced paper.

As used herein, “plain paper” refers to paper that has not been specially coated or designed for specialty uses (e.g., photo printing). Plain paper is composed of cellulose fibers and fillers. In contrast to an enhanced paper (described below), plain paper does not include an additive that produces a chemical interaction with a pigment in an ink that is printed thereon. Also as used herein, “enhanced paper” refers to paper that has not been specially coated, but does include the additive that produces a chemical interaction with a pigment in an ink that is printed thereon. The enhanced paper is composed of cellulose fibers, fillers, and the additive. An example of the additive is calcium chloride or another salt that instantaneously reacts with an anionic pigment present in the ink printed on the enhanced paper, which causes the pigment to crash out of the ink and fixes the pigment on the enhanced paper surface. As an example, the enhanced paper may be any standard paper that incorporates ColorLok® Technology (International Paper Co.). Both plain paper and enhanced paper are commercially available as general office printer and/or copier papers, but, as previously mentioned, the enhanced paper incorporates the ColorLok® Technology. Examples of plain paper used herein include Georgia-Pacific Spectrum Multipurpose paper (from Georgia-Pacific), and Hammermill Great White 30 (from Hammermill). An example of enhanced paper used herein is HP® Multipurpose paper media with COLORLOK® technology (from HP Development Company).

A thermal inkjet ink composition is disclosed herein that exhibits print reliability, as well as relatively consistent print performance attributes on both plain paper and enhanced paper. As illustrated in the examples set forth herein, the thermal inkjet ink composition can be digitally jetted with a thermal inkjet printhead.

The thermal inkjet ink composition incorporates particular amounts of cellulose nanocrystals (CNCs, organic nanocrystals that are isolated from natural sources, such as wood, bark, plants, etc.) in combination with particular amounts of each of a sugar alcohol and an organic salt. Without being bound to any theory, it is believed that these components and their respective amounts have a synergistic effect which renders the ink performance independent of the components of the paper upon which it is printed.

The cellulose nanocrystals can interact with ink pigments to create a shear thinning network which maintains association with the pigments to improve color performance, especially on plain paper. These cellulose nanocrystals may improve color performance better than other gelators (e.g., silica) when present in lower amounts than these other gelators. As an example of the lower amount, the viscosity of an ink including from about 0.5 wt % to about 2 wt % cellulose nanocrystals content is comparable to the viscosity of the same ink including from about 4 wt % to about 7% silica instead of the cellulose nanocrystals. Using cellulose nanocrystals instead of silica reduces ink solids content from about 11.5% to about 6.5%. The reduction in solids content of the inks disclosed herein may alleviate the numerous print reliability issues while providing room for durability enhancing materials (e.g., the sugar alcohol) in the ink composition and overall higher ink efficiency.

An example of the thermal inkjet ink composition comprises cellulose nanocrystals present in an amount ranging from 0.5 wt % up to 3.5 wt %, based on a total weight of the thermal inkjet ink composition; a sugar alcohol present in an amount ranging from 3 wt % up to about 8 wt % based on the total weight of the thermal inkjet ink composition; an organic salt present in an amount ranging from about 0.05 wt % to about 0.5 wt % based on the total weight of the thermal inkjet ink composition; a pigment; a polar solvent; and a balance of water. In other examples, the thermal inkjet ink composition includes these components (e.g., cellulose nanocrystals, sugar alcohol, organic salt, etc.), as well as other additives suitable for thermal inkjet inks, such as, anti-kogation agents, surfactants, humectants, biocides, materials for pH adjustment, sequestering agents, binders, and the like.

In another example, the thermal inkjet ink composition consists of cellulose nanocrystals present in an amount ranging from 0.5 wt % up to 3.5 wt %, based on a total weight of the thermal inkjet ink composition; a sugar alcohol present in an amount ranging from 3 wt % up to about 8 wt % based on the total weight of the thermal inkjet ink composition; an organic salt present in an amount ranging from about 0.05 wt % to about 0.5 wt % based on the total weight of the thermal inkjet ink composition; a pigment; a polar solvent; and a balance of water. In these examples, the previously listed additives are not included in the ink.

The thermal inkjet ink composition includes the cellulose nanocrystals present in an amount ranging from 0.5 wt % up to 3.5 wt %, based on a total weight of the thermal inkjet ink composition.

Cellulose nanocrystals are rod-like anisotropic nanocrystals having an aspect ratio as high as 100. In an example, a length of the cellulose nanocrystals ranges from about 100 nm to about 200 nm, and a width ranges from about 2 nm to about 20 nm. In another example, the length of the cellulose nanocrystals ranges from about 150 nm to about 200 nm, and the width ranges from about 5 nm to about 20 nm. The rod-like cellulose nanocrystals may be more effective than spherical metal oxides (e.g., alumina and silica) in their network building ability. As such, in the example inks disclosed herein, the cellulose nanocrystals may contribute to more colorant remaining on the media surface, even without the presence of calcium ions, thus resulting in an increase in color saturation on plain papers. The hydrodynamic radius (used to determine width) of the cellulose nanocrystals may be determined using a light scattering tool. Other suitable tools that may be used to measure the length and width of the cellulose nanocrystals include TEM (Transmission Electron Microscopy), AFM (Atomic Force Microscopy), and DLS (Dynamic Light Scattering).

The cellulose nanocrystals may be modified cellulose nanocrystals including surface sulfonate groups, surface carboxylate groups, or a combination thereof. Such surface chemistry allows for electrostatic, hydrogen bond, van der Waals, and hydrophobic interactions, which make cellulose nanocrystals an excellent network forming agent.

Cellulose nanocrystals may be incorporated into the ink composition as a dry powder or in the form of a suspension. Suitable cellulose nanocrystal suspensions are commercially available. For example, from about 11.5 wt % to about 12.5 wt % aqueous gel cellulose nanocrystals are available from the University of Maine Process Development Center.

As will be described further herein, the cellulose nanocrystals may be incorporated into an ink vehicle to form the thermal inkjet ink composition. As used herein, the term “ink vehicle,” may refer to the liquid fluid in which cellulose nanocrystals are placed to form the thermal inkjet ink. In an example, the ink vehicle includes the polar solvent and the water, which may also have the sugar alcohol and organic salt dissolved or dispersed therein.

As mentioned herein, the thermal inkjet ink composition includes a sugar alcohol. The sugar alcohol is present in an amount ranging from 3 wt % up to about 8 wt % based on the total weight of the thermal inkjet ink composition. Sugar alcohol levels lower than 3 wt % can lead to poor capped recovery, and that levels higher than 8 wt % can cause a printability issue due to increased viscosity.

The sugar alcohol can be any type of chain or cyclic sugar alcohol. In one example, the sugar alcohol can have the formula: H(HCHO)ₙ₊₁H, where n is at least 3. Such sugar alcohols can include erythritol (4-carbon), threitol (4-carbon), arabitol (5-carbon), xylitol (5-carbon), ribitol (5-carbon), mannitol (6-carbon), sorbitol (6-carbon), galactitol (6-carbon), fucitol (6-carbon), iditol (6-carbon), inositol (6-carbon; a cyclic sugar alcohol), volemitol (7-carbon), isomalt (12-carbon), maltitol (12-carbon), lactitol (12-carbon), and mixtures thereof. In one example, the sugar alcohol can be a 5 carbon sugar alcohol. In another example, the sugar alcohol can be a 6 carbon sugar alcohol. In still another example, the sugar alcohol may be selected from the group consisting of sorbitol, xylitol, mannitol, erythritol, and combinations thereof.

The use of a sugar alcohol can provide excellent curl and rub/scratch resistance over a comparative thermal inkjet ink. In this particular example, the “comparative thermal inkjet ink” refers to the present thermal inkjet ink without the sugar alcohol.

The thermal inkjet ink composition also includes an organic salt. The organic salt is present in an amount ranging from about 0.05 wt % to about 0.5 wt % based on the total weight of the thermal inkjet ink composition.

The organic salts may include tetraethyl ammonium salts, tetramethyl ammonium salts, acetate salts, etc. In another aspect, the salt can include salts of carboxylic acids (e.g., sodium or potassium 2-pyrrolidinone-5-carboxylic acid), sodium or potassium acetate, salts of citric acid or any organic acid including aromatic salts, and mixtures thereof. In one example, the organic salt is selected from the group consisting of sodium phthalate, tetraethyl ammonium, tetramethyl ammonium, monosodium glutamate, bis(trimethylsilyl) malonate, magnesium propionate, magnesium citrate, calcium acetate, magnesium acetate, sodium acetate, potassium acetate, barium acetate, and combinations thereof.

The inclusion of a salt, particularly a dissolved salt in the thermal inkjet ink, can contribute to the structure of the ink. A salt can act to shield the electrostatic repulsion between pigment particles and permit the van der Waals interactions to increase, thereby forming a stronger attractive potential and resulting in a structured network by providing elastic content to a predominantly fluidic system. These structured systems show non-Newtonian flow behavior, thus providing useful characteristics for implementation in an inkjet ink because of their ability to shear or thermal thin for jetting. Once jetted, this feature allows the jetted drops to become more elastic-, mass-, or gel-like when they strike the media surface. These characteristics can also provide improved media attributes, such as colorant holdout on the surface of plain paper. The role of salt can impact both the jettability and the response after jetting.

The thermal inkjet ink composition also includes a polar solvent. It is desirable for the solvent to be miscible with water, and thus the solvent has at least some degree of polarity. In an example, the solvent is selected from the group consisting of 2-pyrrolidone (2P), 1-(2-hydroxyethyl)-2-pyrrolidone (HE2P), 2-ethyl-2-hydroxymethyl-1,3-propanediol) (EHPD), tetraethylene glycol (TEG) and combinations thereof. The solvent may be present in an amount ranging from about 10 wt % to about 50 wt % based on the total weight of the thermal inkjet ink composition.

The thermal inkjet ink composition also includes a pigment. As used herein, “pigment” may include charge dispersed (i.e., self-dispersed) organic or inorganic pigment colorants. The pigment may be any color, including, as examples, a cyan pigment, a magenta pigment, a yellow pigment, a black pigment, a violet pigment, a green pigment, a brown pigment, an orange pigment, a purple pigment, a white pigment, or combinations thereof. The following examples of suitable pigments can be charged and thus made self-dispersible.

Examples of suitable blue or cyan organic pigments include C.I. Pigment Blue 1, C.I. Pigment Blue 2, C.I. Pigment Blue 3, C.I. Pigment Blue 15, Pigment Blue 15:3, C.I. Pigment Blue 15:34, C.I. Pigment Blue 15:4, C.I. Pigment Blue 16, C.I. Pigment Blue 18, C.I. Pigment Blue 22, C.I. Pigment Blue 25, C.I. Pigment Blue 60, C.I. Pigment Blue 65, C.I. Pigment Blue 66, C.I. Vat Blue 4, and C.I. Vat Blue 60.

Examples of suitable magenta, red, or violet organic pigments include C.I. Pigment Red 1, C.I. Pigment Red 2, C.I. Pigment Red 3, C.I. Pigment Red 4, C.I. Pigment Red 5, C.I. Pigment Red 6, C.I. Pigment Red 7, C.I. Pigment Red 8, C.I. Pigment Red 9, C.I. Pigment Red 10, C.I. Pigment Red 11, C.I. Pigment Red 12, C.I. Pigment Red 14, C.I. Pigment Red 15, C.I. Pigment Red 16, C.I. Pigment Red 17, C.I. Pigment Red 18, C.I. Pigment Red 19, C.I. Pigment Red 21, C.I. Pigment Red 22, C.I. Pigment Red 23, C.I. Pigment Red 30, C.I. Pigment Red 31, C.I. Pigment Red 32, C.I. Pigment Red 37, C.I. Pigment Red 38, C.I. Pigment Red 40, C.I. Pigment Red 41, C.I. Pigment Red 42, C.I. Pigment Red 48(Ca), C.I. Pigment Red 48(Mn), C.I. Pigment Red 57(Ca), C.I. Pigment Red 57:1, C.I. Pigment Red 88, C.I. Pigment Red 112, C.I. Pigment Red 114, C.I. Pigment Red 122, C.I. Pigment Red 123, C.I. Pigment Red 144, C.I. Pigment Red 146, C.I. Pigment Red 149, C.I. Pigment Red 150, C.I. Pigment Red 166, C.I. Pigment Red 168, C.I. Pigment Red 170, C.I. Pigment Red 171, C.I. Pigment Red 175, C.I. Pigment Red 176, C.I. Pigment Red 177, C.I. Pigment Red 178, C.I. Pigment Red 179, C.I. Pigment Red 184, C.I. Pigment Red 185, C.I. Pigment Red 187, C.I. Pigment Red 202, C.I. Pigment Red 209, C.I. Pigment Red 219, C.I. Pigment Red 224, C.I. Pigment Red 245, C.I. Pigment Red 286, C.I. Pigment Violet 19, C.I. Pigment Violet 23, C.I. Pigment Violet 32, C.I. Pigment Violet 33, C.I. Pigment Violet 36, C.I. Pigment Violet 38, C.I. Pigment Violet 43, and C.I. Pigment Violet 50.

Examples of suitable yellow organic pigments include C.I. Pigment Yellow 1, C.I. Pigment Yellow 2, C.I. Pigment Yellow 3, C.I. Pigment Yellow 4, C.I. Pigment Yellow 5, C.I. Pigment Yellow 6, C.I. Pigment Yellow 7, C.I. Pigment Yellow 10, C.I. Pigment Yellow 11, C.I. Pigment Yellow 12, C.I. Pigment Yellow 13, C.I. Pigment Yellow 14, C.I. Pigment Yellow 16, C.I. Pigment Yellow 17, C.I. Pigment Yellow 24, C.I. Pigment Yellow 34, C.I. Pigment Yellow 35, C.I. Pigment Yellow 37, C.I. Pigment Yellow 53, C.I. Pigment Yellow 55, C.I. Pigment Yellow 65, C.I. Pigment Yellow 73, C.I. Pigment Yellow 74, C.I. Pigment Yellow 75, C.I. Pigment Yellow 77, C.I. Pigment Yellow 81, C.I. Pigment Yellow 83, C.I. Pigment Yellow 93, C.I. Pigment Yellow 94, C.I. Pigment Yellow 95, C.I. Pigment Yellow 97, C.I. Pigment Yellow 98, C.I. Pigment Yellow 99, C.I. Pigment Yellow 108, C.I. Pigment Yellow 109, C.I. Pigment Yellow 110, C.I. Pigment Yellow 113, C.I. Pigment Yellow 114, C.I. Pigment Yellow 117, C.I. Pigment Yellow 120, C.I. Pigment Yellow 122, C.I. Pigment Yellow 124, C.I. Pigment Yellow 128, C.I. Pigment Yellow 129, C.I. Pigment Yellow 133, C.I. Pigment Yellow 138, C.I. Pigment Yellow 139, C.I. Pigment Yellow 147, C.I. Pigment Yellow 151, C.I. Pigment Yellow 153, C.I. Pigment Yellow 154, C.I. Pigment Yellow 167, C.I. Pigment Yellow 172, C.I. Pigment Yellow 180, and C.I. Pigment Yellow 185.

Carbon black may be a suitable inorganic black pigment. Examples of carbon black pigments include those manufactured by Mitsubishi Chemical Corporation, Japan (such as, e.g., carbon black No. 2300, No. 900, MCF88, No. 33, No. 40, No. 45, No. 52, MA7, MA8, MA100, and No. 2200B); various carbon black pigments of the RAVEN® series manufactured by Columbian Chemicals Company, Marietta, Ga., (such as, e.g., RAVEN® 5750, RAVEN® 5250, RAVEN® 5000, RAVEN® 3500, RAVEN® 1255, and RAVEN® 700); various carbon black pigments of the REGAL® series, the MOGUL® series, or the MONARCH® series manufactured by Cabot Corporation, Boston, Mass., (such as, e.g., REGAL® 400R, REGAL® 330R, REGAL® 660R, MOGUL® E, MOGUL® L, AND ELFTEX® 410); and various black pigments manufactured by Evonik Degussa Orion Corporation, Parsippany, N.J., (such as, e.g., Color Black FW1, Color Black FW2, Color Black FW2V, Color Black FW18, Color Black FW200, Color Black S150, Color Black S160, Color Black S170, PRINTEX® 35, PRINTEX® U, PRINTEX® V, PRINTEX® 140U, Special Black 5, Special Black 4A, and Special Black 4). An example of an organic black pigment includes aniline black, such as C.I. Pigment Black 1.

Some examples of green organic pigments include C.I. Pigment Green 1, C.I. Pigment Green 2, C.I. Pigment Green 4, C.I. Pigment Green 7, C.I. Pigment Green 8, C.I. Pigment Green 10, C.I. Pigment Green 36, and C.I. Pigment Green 45.

Examples of brown organic pigments include C.I. Pigment Brown 1, C.I. Pigment Brown 5, C.I. Pigment Brown 22, C.I. Pigment Brown 23, C.I. Pigment Brown 25, C.I. Pigment Brown 41, and C.I. Pigment Brown 42.

Some examples of orange organic pigments include C.I. Pigment Orange 1, C.I. Pigment Orange 2, C.I. Pigment Orange 5, C.I. Pigment Orange 7, C.I. Pigment Orange 13, C.I. Pigment Orange 15, C.I. Pigment Orange 16, C.I. Pigment Orange 17, C.I. Pigment Orange 19, C.I. Pigment Orange 24, C.I. Pigment Orange 34, C.I. Pigment Orange 36, C.I. Pigment Orange 38, C.I. Pigment Orange 40, C.I. Pigment Orange 43, and C.I. Pigment Orange 66.

The average particle size of the pigments may range anywhere from about 50 nm to about 200 nm. In an example, the average particle size ranges from about 80 nm to about 150 nm.

The pigment may be incorporated into the thermal inkjet ink composition in the form of a pigment dispersion, in which the pigment is self-dispersed. In the examples disclosed herein, the pigment may be present in the ink composition in an amount ranging from about 2 wt % to about 5 wt % based on the total weight of the ink. In another example, the pigment amount ranges from about 4 wt % to about 5 wt % based on the total weight of the ink. When the pigment is added in the form of a pigment dispersion, the amount of dispersion may be selected so that from about 2% actives (i.e., pigment) to about 5% actives is incorporated into the thermal inkjet ink composition. It is to be understood that the active percentage accounts for the pigment amount, and does not reflect the amount of other dispersion components that may be included.

The balance of the thermal inkjet ink composition is water. As such, the amount of water included may vary, depending upon the amounts of the other thermal inkjet ink components. In an example, the water is deionized water.

The total solids content of the thermal inkjet ink composition is less than about 10 wt % based on the total weight of the thermal inkjet ink composition.

In some examples, the thermal inkjet ink composition further comprises a dye present in an amount ranging from about 0.2 wt % to about 0.5 wt % based on the total weight of the thermal inkjet ink composition. Examples of suitable dyes include azo dyes, phthalocyanine dyes, direct dyes, vat dyes, sulfur dyes, organic dyes, reactive dyes, disperse dyes, acid dyes, or basic dyes. Examples of suitable dyes are commercially available, and include azo dyes (such as PRO-JET™ Fast Magenta 2 Liquid (from Fujifilm, USA)), and phthalocyanine dye (Nippon Kayaku, Japan). The dye may also be any desirable color, such as black, magenta, cyan, yellow, etc.

Examples of the thermal inkjet ink composition may also include other components, such as anti-kogation agents, surfactants, humectants, biocides, materials for pH adjustment, sequestering agents, binders, and the like.

Kogation refers to the deposit of dried ink on a heating element of a thermal inkjet printhead. Anti-kogation agent(s) is/are included to assist in preventing the buildup of kogation. Examples of suitable anti-kogation agents include oleth-3-phosphate (commercially available as CRODAFOS™ 03 A or CRODAFOS™ N-3 acid) or dextran 500 k. Other suitable examples of the anti-kogation agents include CRODAFOS™ HCE (phosphate-ester from Croda Int.), CRODAFOS® N10 (oleth-10-phosphate from Croda Int.), or DISPERSOGEN® LFH (polymeric dispersing agent with aromatic anchoring groups, acid form, anionic, from Clariant), etc. The anti-kogation agent may be present in the thermal inkjet ink composition in an amount ranging from about 0.05 wt % to about 1 wt % of the total weight of the thermal inkjet ink composition. In the examples disclosed herein, the anti-kogation agent may improve the jettability of the thermal inkjet ink composition.

Examples of suitable surfactants include sodium dodecyl sulfate (SDS), a linear, N-alkyl-2-pyrrolidone (e.g., SURFADONE™ LP-100 from Ashland Inc.), a self-emulsifiable, nonionic wetting agent based on acetylenic diol chemistry (e.g., SURFYNOL® SEF from Evonik Ind.), a nonionic fluorosurfactant (e.g., CAPSTONE® fluorosurfactants, such as CAPSTONE® FS-35, from DuPont, previously known as ZONYL FSO), and combinations thereof. In other examples, the surfactant is an ethoxylated low-foam wetting agent (e.g., SURFYNOL® 440 or SURFYNOL® CT-111 from Evonik Ind.) or an ethoxylated wetting agent and molecular defoamer (e.g., SURFYNOL® 420 from Evonik Ind.). Still other suitable surfactants include non-ionic wetting agents and molecular defoamers (e.g., SURFYNOL® 104E from Evonik Ind.) or water-soluble, non-ionic surfactants (e.g., TERGITOL™ TMN-6, TERGITOL™ 15-S-7, or TERGITOL™ 15-S-9 (a secondary alcohol ethoxylate) from The Dow Chemical Company or TEGO® Wet 510 (polyether siloxane) available from Evonik Ind.). In some examples, it may be desirable to utilize a surfactant having a hydrophilic-lipophilic balance (HLB) less than 10. Whether a single surfactant is used or a combination of surfactants is used, the total amount of surfactant(s) in the thermal inkjet ink composition may range from about 0.01 wt % to about 10 wt % based on the total weight of the thermal inkjet ink composition. In an example, the total amount of surfactant(s) in the thermal inkjet ink composition may be about 0.1 wt % based on the total weight of the thermal inkjet ink composition.

The thermal inkjet ink composition may also include humectant(s). In an example, the total amount of the humectant(s) present in the thermal inkjet ink composition ranges from about 1 wt % to about 1.25 wt %, based on the total weight of the thermal inkjet ink composition. An example of a suitable humectant is LIPONIC® EG-1 (i.e., LEG-1, glycereth-26, ethoxylated glycerol, available from Lipo Chemicals).

The thermal inkjet ink composition may also include biocides (i.e., fungicides, anti-microbials, etc.). Example biocides may include the NUOSEPT™ (Troy Corp.), UCARCIDE™ (Dow Chemical Co.), ACTICIDE® B20 (Thor Chemicals), ACTICIDE® M20 (Thor Chemicals), ACTICIDE® MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant), blends of 5-chloro-2-methyl-4-isothiazolin-3-one (CIT or CMIT) and MIT under the tradename KATHON™ (Dow Chemical Co.), and combinations thereof. Examples of suitable biocides include an aqueous solution of 1,2-benzisothiazolin-3-one (e.g., PROXEL® GXL from Arch Chemicals, Inc.), quaternary ammonium compounds (e.g., BARDAC® 2250 and 2280, BARQUAT® 50-65B, and CARBOQUAT® 250-T, all from Lonza Ltd. Corp.), and an aqueous solution of methylisothiazolone (e.g., KORDEK® MLX from Dow Chemical Co.). In an example, the thermal inkjet ink composition may include a total amount of biocides that ranges from about 0.05 wt % to about 1 wt %.

The thermal inkjet ink composition disclosed herein may have a pH ranging from about 7 to about 10, and pH adjuster(s) may be added to the thermal inkjet ink composition to counteract any slight pH drop that may occur over time. In an example, the total amount of pH adjuster (s) in the thermal inkjet ink composition ranges from greater than 0 wt % to about 0.1 wt % (with respect to the total weight of the thermal inkjet ink composition). Examples of suitable pH adjusters include metal hydroxide bases, such as sodium hydroxide (NaOH), potassium hydroxide (KOH), etc.

Sequestering agents (or chelating agents) may be included in the thermal inkjet ink composition to eliminate the deleterious effects of heavy metal impurities. Examples of sequestering agents include disodium ethylenediaminetetraacetic acid (EDTA-Na), ethylene diamine tetra acetic acid (EDTA), and methylglycinediacetic acid (e.g., TRILON® M from BASF Corp.). Whether a single sequestering agent is used or a combination of sequestering agents is used, the total amount of sequestering agent(s) in the thermal inkjet ink composition may range from greater than 0 wt % to about 2 wt % based on the total weight of the thermal inkjet ink composition.

The thermal inkjet ink composition may also include a binder. Example binders may include a polyurethane binder, a styrene acrylic binder, or the like. In an example, the thermal inkjet ink composition may include a total amount of binder up to about 1 wt % based on the total weight of the thermal inkjet ink composition. In an example, the binder amount ranges from greater than 0 wt % to about 0.6 wt % based on the total weight of the thermal inkjet ink composition.

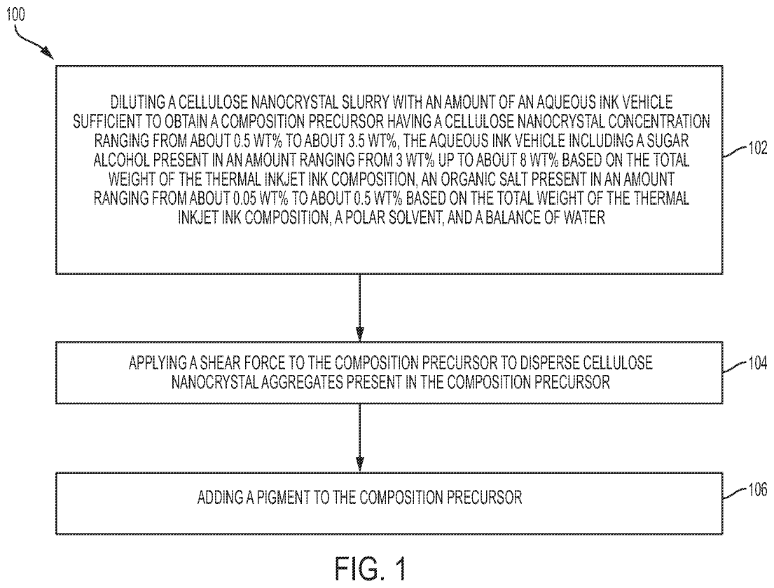

In addition to the thermal inkjet ink composition described herein, a method 100 for making the thermal inkjet ink composition is disclosed. Turning now to FIG. 1, the method 100 comprises diluting a cellulose nanocrystal (CNC) slurry with an amount of an aqueous ink vehicle sufficient to obtain a composition precursor having a cellulose nanocrystal concentration ranging from about 0.5 wt % to about 3.5 wt %, the aqueous ink vehicle including a sugar alcohol present in an amount ranging from 3 wt % up to about 8 wt % based on the total weight of the thermal inkjet ink composition, an organic salt present in an amount ranging from about 0.05 wt % to about 0.5 wt % based on the total weight of the thermal inkjet ink composition, a polar solvent, and a balance of water (as shown at reference numeral 102); applying a shear force to the composition precursor to disperse cellulose nanocrystal aggregates present in the composition precursor (as shown at reference numeral 104); and adding a pigment to the composition precursor (as shown at reference numeral 106).

In one example, the cellulose nanocrystal slurry may be a commercially available suspension that has at least 10% w/v of cellulose nanocrystals. At this concentration, the aggregates are likely to be present in the slurry, and the subsequent application of shear force can help to disperse the aggregates into individual cellulose nanocrystals.

In another example, prior to diluting the cellulose nanocrystal slurry, the method may further comprise making the cellulose nanocrystal slurry so that a concentration of cellulose nanocrystals in the cellulose nanocrystal slurry is at least 10% w/v, and the cellulose nanocrystal aggregates form in the cellulose nanocrystal slurry.

The cellulose nanocrystal slurry may be formed by exposing a dispersion of cellulose microfibrils to acid hydrolysis, followed by sonication, purification, and water reduction.

When preparing the slurry, acid hydrolysis may be accomplished using sulfuric acid, hydrochloric acid, or combinations thereof. The sulfuric acid or the combination of hydrochloric and sulfuric acids may be used when it is desirable to introduce at least some sulfonate groups to the surface of the cellulose nanocrystals to form self-dispersed cellulose nanocrystals. As such, in some examples the cellulose nanocrystal slurry includes cellulose nanocrystals including surface sulfonate groups, and the method 100 further comprises forming the cellulose nanocrystal slurry by exposing a dispersion of cellulose nanocrystals to acid hydrolysis using sulfuric acid. In other examples, the hydrochloric acid may be used when sulfonation is not desired. This process forms another example of the cellulose nanocrystals. In some examples, after acid hydrolysis, the method may further comprise exposing the cellulose nanocrystals to oxidants or esterification agents to obtain at least partially carboxylated cellulose nanocrystals. In other examples, additional sulfuric acid may be added in order to enrich the degree of sulfonation.

After acid hydrolysis, a 1% or lower concentration of cellulose nanocrystal slurry may be obtained, which may be exposed to further purification and water reduction. The purification and water reduction may be accomplished by centrifugation, which may be performed once or multiple times, e.g., at least 3.

Purified cellulose nanocrystal slurries can be spray dried, freeze dried, or prepared into a slurry of at least 10% w/v cellulose nanocrystal concentration by adjusting the water amount. These techniques may result in the formation of cellulose nanocrystal aggregates. Spray dried or freeze dried cellulose nanocrystal aggregates may also be added to water to form a slurry of the desired concentration.

It may then be desirable to expose the slurry to sonication to re-disperse the cellulose nanocrystals. While sonication may be used with any of the cellulose nanocrystals that are formed, it may be particularly desirable for the cellulose nanocrystals formed with hydrochloric acid, as these cellulose nanocrystals do not have surface charged groups to achieve self-dispersion, and the sonication can aid in the dispersion of these types of cellulose nanocrystals.

At reference numeral 104, the method 100 continues by applying a shear force to the composition precursor to disperse cellulose nanocrystal aggregates present in the composition precursor. The parameters involved with the application of shear force depend, at least in part, on the technique used to apply the force, the volume of the composition precursor, and the cellulose nanocrystal loading in the composition precursor. In an example, the shear force is applied using sonication. Sonication may be performed at a frequency ranging from about 20 kHz to about 40 kHz. The sonication may be performed on ice for a time ranging from about 2 minutes to about 6 minutes. In an example, about 150 mL of the composition precursor may be sonicated, although the volume may be adjusted depending on the probe tip diameter used. As examples, a 55 mm diameter probe may be used with volumes of about 150 mL or less, whereas a 6 mm probe may be used with volumes of about 15 mL of less.

At reference numeral 106, the method 100 further includes adding a pigment to the composition precursor. The pigment may be added before shearing takes place or after shearing takes place.

A printing method for using the thermal inkjet ink composition is also disclosed herein. The method comprises introducing a plain paper into a thermal inkjet printer, the plain paper excluding an additive that produces a chemical interaction with a pigment in an ink composition that is printed thereon, and from the thermal inkjet printer, jetting an ink composition onto the plain paper to form an image, the ink composition including cellulose nanocrystals present in an amount ranging from 0.5 wt % up to 3.5 wt %, based on a total weight of the thermal inkjet ink composition, a sugar alcohol present in an amount ranging from 3 wt % up to about 8 wt % based on the total weight of the thermal inkjet ink composition, an organic salt present in an amount ranging from about 0.05 wt % to about 0.5 wt % based on the total weight of the thermal inkjet ink composition, a pigment, a polar solvent, and a balance of water.

The printing method further comprises jetting the ink composition onto an enhanced paper to form an other image, the enhanced paper including an additive that produces a chemical interaction with the pigment in the ink composition, wherein color saturation of the image on the plain paper is within 0.1 of color saturation of the other image on the enhanced paper at any given % fill density.

To further illustrate the present disclosure, examples are given herein. It is to be understood that these examples are provided for illustrative purposes and are not to be construed as limiting the scope of the present disclosure.

### EXAMPLES

### Example 1

An example of a cyan ink and an example of a magenta ink were prepared in accordance with the examples disclosed herein. The formulations of the example inks are presented in Table 1 below. The percentages represent weight percentages of actives of the individual components.

TABLE 1

| | | Cyan Ink | Magenta Ink |
|---|---|---|---|
| Ingredient | Specific Component | (wt %) | (wt %) |
| Solvent | Tetraethylene glycol | 0 | 5 |
| | Triethylene glycol | 6 | 0 |
| | 2-pyrrolidone | 13 | 13 |
| Humectant | LIPONIC ® EG-1 (Lipo | 1 | 0 |
| | Chemicals) | | |
| Sugar Alcohol | Sorbitol | 6 | 7 |
| Salt | Sodium phthalate | 0.12 | 0.15 |
| Network Agent | Cellulose nanocrystals | 2 | 2 |
| Colorant | CAB-O-JET ® 450C, cyan | 4.5 | 0 |
| | pigment (Cabot Corp.) | | |
| | Phthalocyanine dye | 0.3 | 0 |
| | (Nippon Kayaku) | | |
| | CAB-O-JET ® 465M | 0 | 4.5 |
| | magent apigment (Cabot | | |
| | Corp.) | | |
| | PRO-JET ™ Fast | 0 | 0.35 |
| | Magenta 2 dye | | |
| | (Fujifilm USA) | | |
| Surfactant | Sodium dodecyl sulfate | 0.05 | 0 |
| | SURFADONE ™ LP-100 | 0 | 0.1 |
| | (Ashland Inc.) | | |
| Anti-kogation | CRODAFOS ™ O3A | 0.05 | 0 |
| Agent | (Croda Int.) | | |
| Water | Deionized Water | Balance | Balance |
| pH 8-9 | | | |

The water, solvents, sugar alcohol, salt, humectant (for cyan), surfactant, and anti-kogation agent (for cyan) were mixed together to form aqueous ink vehicles. The inks were prepared using a cellulose nanocrystal slurry (11.8% w/v) available from the University of Maine Process Development Center. Applicable amounts of the slurry were added to the respective aqueous ink vehicles to obtain the weight percent of cellulose nanocrystals listed in Table 1, and to form cyan and magenta composition precursors. The composition precursors were exposed to sonication to apply shear force and to break cellulose nanocrystal agglomerates and liberate individual cellulose nanocrystals. Sonication was performed at a frequency ranging from about 20 kHz to about 40 kHz using a 55 mm probe tip diameter. 150 mL of each of the cyan and magenta composition precursor was sonicated at a time, and the sonication was performed on ice for a time ranging from about 2 minutes to about 6 minutes, or until a clear suspension was obtained.

The cyan colorants were added to the clear suspension (with the cyan vehicle components), and the magenta colorants were added to the clear suspension (with the magenta vehicle components) to form the example thermal inkjet inks.

A comparative example of a magenta ink was also prepared. The comparative example magenta ink included cellulose nanocrystals, but did not include the sugar alcohol or the salt. The formulation of the comparative example magenta ink is presented in Table 2 below. The percentages represent weight percentages of actives of the individual components.

TABLE 2

| | | Comparative |
|---|---|---|
| | | Magenta Ink |
| Ingredient | Specific Component | (wt %) |
| Solvent | Glycerol | 5 |
| Network Agent | cellulose nanocrystals | 2.87 |
| Colorant | CAB-O-JET ® 465M magenta | 4.5 |
| | pigment (Cabot Corp.) | |
| | PRO-JET ™ Fast Magenta | 0.3 |
| | 2 dye (Fujifilm USA) | |
| Surfactant | SURFYNOL ® 465 (Evonik | 1 |
| | Ind.) | |
| Water | Deionized Water | Balance |
| pH 8 | | |

The water, solvents, and surfactant, were mixed together to form an aqueous ink vehicle. The comparative ink was prepared using the cellulose nanocrystal slurry (11.8% w/v), and an applicable amount of the slurry was added to the aqueous ink vehicle to obtain the weight percent of cellulose nanocrystals listed in Table 2. This formed a comparative magenta composition precursor. The comparative composition precursor was exposed to sonication as described above for the cyan and magenta example inks. The magenta colorants were then added to form the comparative example magenta ink.

Each of the cyan ink, the magenta ink, and the comparative magenta ink was printed with a thermal inkjet printer, the HP® OFFICEJET® Pro 8000. The example cyan and magenta inks were each printed on a plain paper (Georgia-Pacific Spectrum Multipurpose paper, referred to herein as PP1), and on an enhanced paper (HP® Multipurpose paper media with COLORLOK® technology, referred to herein as EP). These inks were printed at different percentages of fill density (ranging from 24% to 64%). The comparative example magenta ink was printed on PP1, and on EP, and on another plain paper (Hammermill Great White 30, referred to herein as PP2). This ink was printed at different percentages of fill density (ranging from 30% to 60%).

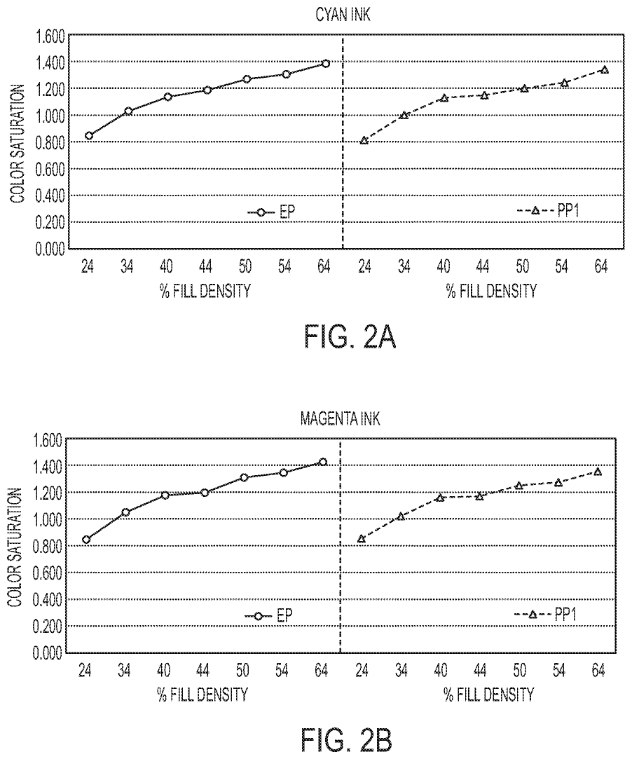

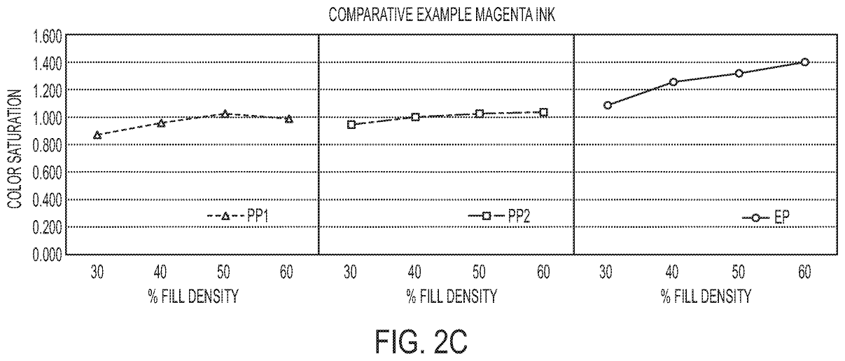

The color saturation of each printed image was measured using an EXACT™ spectrophotometer, from X-Rite Pantone. The color saturation results for the cyan ink at the different fill densities on the different papers are shown in FIG. 2A, and the color saturation results for the magenta ink at the different fill densities on the different papers are shown in FIG. 2B, and the color saturation results for the comparative example magenta ink at the different fill densities on the different papers are shown in FIG. 2C.

As shown in FIGS. 2A and 2B, each of the cyan ink and the magenta ink exhibited similar color saturation results on each of the plain and enhanced papers. Both the cyan ink and the magenta ink exhibited an upward trend in color saturation as the fill density increased on the enhanced paper. For each of the inks, this trend was also observed on the plain paper. These results illustrate that both the cyan and magenta inks are media independent in terms of color performance.

The results in FIG. 2C illustrate that the comparative example magenta ink did not perform as well on the plain papers PP1, PP2 as it did on the enhanced paper EP. On each of the plain papers PP1 and PP2, the color saturation of the comparative example magenta ink never went above 1.1, even at the highest fill density. All of the color saturation results for the comparative example magenta ink on the plain papers were lower than the color saturation results for this ink on the enhanced paper EP (even at the lowest fill density). The comparative example magenta ink performed well on the enhanced paper, likely due to the COLORLOK® technology in the paper. However, there was no consistency of the color saturation across the different paper types.

Comparing FIGS. 2C and 2B, the example magenta ink performed better than the comparative example magenta ink, in terms of color saturation, on plain paper PP1, especially at the higher fill densities. Moreover, the performance of the example magenta ink was consistent on different paper types, whereas the comparative example magenta ink performed much worse on plain paper than enhanced paper. These results indicate that the sugar alcohol and/or the salt impact the performance of the ink containing cellulose nanocrystals.

The example magenta ink and the comparative example magenta ink were also tested for decap performance. The term “decap performance,” as referred to herein, means the ability of the thermal inkjet ink to readily eject from the printhead, upon prolonged exposure to air. The decap time is measured as the amount of time that a printhead may be left uncapped (i.e., exposed to air) before the printer nozzles no longer fire properly, potentially because of clogging, plugging, or retraction of the colorant from the drop forming region of the nozzle/firing chamber. The length of time a thermal inkjet pen can remain unused and uncapped before spitting would be required to form an acceptable quality ink drop is called decap time. A decreased decap time can lead to poor print reliability performance. The decap time for the example magenta ink was between 1 and 2 seconds. In contrast, the decap time for the comparative example magenta ink was less than 1 second.

### Example 2

Secondary colored inks were prepared using the cyan ink from Example 1 and/or the magenta ink from Example 1. A red ink was prepared by mixing the magenta ink and a yellow ink (similar to commercially available yellow inks from HP, such as HP933 and HP951) (at a M:Y ratio of 4:1). A green ink was prepared by mixing the cyan ink and the yellow ink (at a C:Y ratio of 1.28:1). A blue ink was prepared by mixing the cyan ink and the magenta ink (at a C:M ratio of 3:1).

Each of the red ink, the green ink, and the blue ink was printed with a thermal inkjet printer, HP® Officejet Pro 8000. The example red ink, green ink, and blue ink were each printed on PP1, PP2, and on EP. These inks were printed at different percentages of fill density (ranging from 25% to 65%).

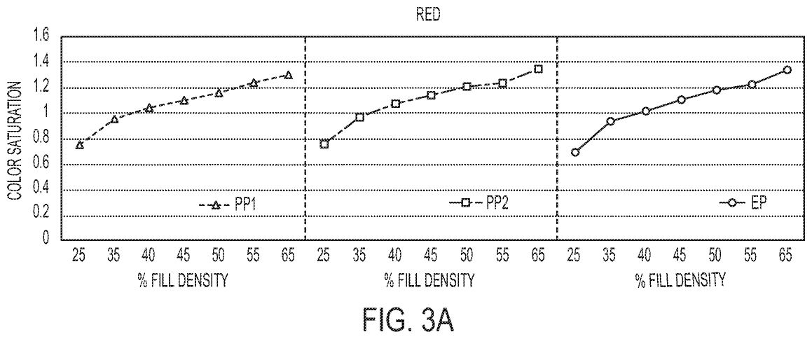

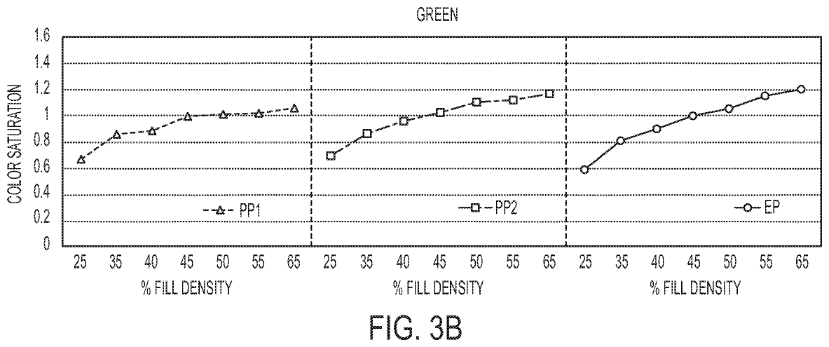

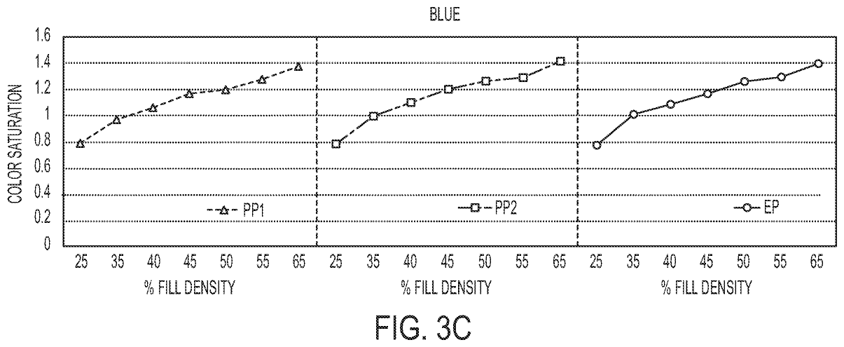

The color saturation of each printed image was measured using an EXACT™ spectrophotometer, from X-Rite Pantone. The color saturation results for the red ink at the different fill densities on the different papers are shown in FIG. 3A, the color saturation results for the green ink at the different fill densities on the different papers are shown in FIG. 3B, and the color saturation results for the blue ink at the different fill densities on the different papers are shown in FIG. 3C.

As shown in FIGS. 3A, 3B, and 3C, each of the secondary colored inks exhibited similar color saturation results on each of the plain papers PP1 and PP2 and on the enhanced paper EP. Each of the red, green, and blue inks exhibited an upward trend in color saturation as the fill density increased on the enhanced paper EP. For each of the inks, this trend was also observed on the plain papers PP1 and PP2. These results illustrate that secondary colored inks (formed with the example cyan and magenta inks disclosed herein) are also media independent in terms of color performance.

### Example 3

The example magenta ink from Example 1 was also used in this Example. The print performance of the example magenta ink was compared with the print performance of two additional comparative example magenta inks, referred to as CEM2 and CEM3.

CEM2 and CEM3 each included a higher weight percent of cellulose nanocrystals than the example magenta ink. The formulations of CEM2 and CEM3 are presented in Table 3 below. The percentages represent weight percentages of actives of the individual components.

TABLE 3

| | | CEM2 | CEM3 |
|---|---|---|---|
| Ingredient | Specific Component | (wt %) | (wt %) |
| Solvent | Glycerol | 5 | 5 |
| Network Agent | cellulose nanocrystals | 4 | 4 |
| Colorant | CAB-O-JET ® 465M magenta | 4.5 | 4.5 |
| | pigment (Cabot Corp.) | | |
| | PRO-JET ™ Fast Magenta | 0.3 | 0 |
| | 2 dye (Fujifilm USA) | | |
| Surfactant | SURFYNOL ® 465 (Evonik | 1 | 1 |
| | Ind.) | | |
| Sugar Alcohol | Sorbitol | 3 | 3 |
| Water | Deionized Water | Balance | Balance |
| pH 8 | | | |

The water, solvents, sugar alcohol, and surfactant were mixed together to form an aqueous ink vehicle. CEM2 and CEM3 were prepared using the cellulose nanocrystal slurry (11.8% w/v), and an applicable amount of the slurry was added to the aqueous ink vehicle to obtain the weight percent of cellulose nanocrystals listed in Table 3. This formed CEM2 and CEM3 composition precursors. The CEM2 and CEM3 comparative composition precursors were exposed to sonication as described above for the cyan and magenta example inks. The magenta colorants were then added to form CEM2, and the magenta pigment dispersion (without the dye) was then added to form CEM3.

An attempt was made to print CEM2 with a thermal inkjet printer, however, the ink would not print. This may have been due to the combination of the dye with the higher percentage of cellulose nanocrystals. The dye may increase the gel-like character of the cellulose nanocrystal network, thereby preventing the ink from printing.

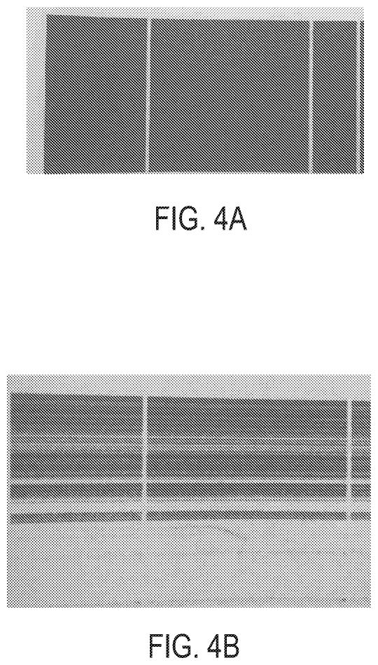

Each of the example magenta ink and CEM3 was printed (at 50% print density) with the thermal inkjet printer on the enhanced paper EP. The example magenta ink print is shown in black and white in FIG. 4A, and the CEM3 print is shown in black and white in FIG. 4B. As shown in FIG. 4B, CEM3, with a higher cellulose nanocrystal loading, did print, but experienced many missing nozzles, resulting in a poor quality print. The printing performance also appeared to degrade with time, potentially indicating that the cellulose nanocrystals were aggregating and clogging printhead nozzles. These results indicate that higher cellulose nanocrystal amounts result in inks that do not print via a thermal inkjet printhead, or result in inks that print unreliably from a thermal inkjet printhead. However, as illustrated by the results for the example magenta ink, lower amounts of cellulose nanocrystals, in combination with the sugar alcohol and organic salt disclosed herein, renders an ink whose performance is independent of the components of the paper upon which it is printed.

It is to be understood that the ranges provided herein include the stated range and any value or sub-range within the stated range. For example, a range from 0.5 wt % up to 3.5 wt % should be interpreted to include not only the explicitly recited limits of 0.5 wt % up to 3.5 wt %, but also to include individual values, such as 0.75 wt %, 1.25 wt %, 1 wt %, 2.55 wt %, etc., and sub-ranges, such as from about 0.55 wt % to about 3 wt %, from about 1.5 wt % to about 2.7 wt %, etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A thermal inkjet ink composition, comprising:
cellulose nanocrystals present in an amount ranging from 0.5 wt % up to 3.5 wt %, based on a total weight of the thermal inkjet ink composition;
a sugar alcohol present in an amount ranging from 3 wt % up to about 8 wt % based on the total weight of the thermal inkjet ink composition;
an organic salt present in an amount ranging from about 0.05 wt % to about 0.5 wt % based on the total weight of the thermal inkjet ink composition;
a pigment;
a polar solvent; and
a balance of water.

2. The thermal inkjet ink composition as defined in claim 1, further comprising a dye present in an amount ranging from about 0.2 wt % to about 0.5 wt % based on the total weight of the thermal inkjet ink composition.

3. The thermal inkjet ink composition as defined in claim 1 wherein the organic salt is selected from the group consisting of sodium phthalate, tetraethyl ammonium, tetramethyl ammonium, monosodium glutamate, bis(trimethylsilyl) malonate, magnesium propionate, magnesium citrate, calcium acetate, magnesium acetate, sodium acetate, potassium acetate, barium acetate, and combinations thereof.

4. The thermal inkjet ink composition as defined in claim 1 wherein the sugar alcohol is selected from the group consisting of sorbitol, xylitol, mannitol, erythritol, and combinations thereof.

5. The thermal inkjet ink composition as defined in claim 1 wherein a length of the cellulose nanocrystals ranges from about 100 nm to about 200 nm, and a width ranges from about 2 nm to about 20 nm.

6. The thermal inkjet ink composition as defined in claim 1 wherein the cellulose nanocrystals are modified cellulose nanocrystals including surface sulfonate groups, surface carboxylate groups, or a combination thereof.

7. The thermal inkjet ink composition as defined in claim 1 wherein a total solids content of the thermal inkjet ink composition is less than about 10 wt % based on the total weight of the thermal inkjet ink composition.

8. A method for making a thermal inkjet ink composition, comprising:
diluting a cellulose nanocrystal slurry with an amount of an aqueous ink vehicle sufficient to obtain a composition precursor having a cellulose nanocrystal concentration ranging from about 0.5 wt % to about 3.5 wt %, the aqueous ink vehicle including:
a sugar alcohol present in an amount ranging from 3 wt % up to about 8 wt % based on the total weight of the thermal inkjet ink composition;
an organic salt present in an amount ranging from about 0.05 wt % to about 0.5 wt % based on the total weight of the thermal inkjet ink composition;
a polar solvent; and
a balance of water;
applying a shear force to the composition precursor to disperse cellulose nanocrystal aggregates present in the composition precursor; and
adding a pigment to the composition precursor.

9. The method as defined in claim 8 wherein prior to diluting the cellulose nanocrystal slurry, the method further comprises making the cellulose nanocrystal slurry so that a concentration of cellulose nanocrystals in the cellulose nanocrystal slurry is at least 10% w/v, and the cellulose nanocrystal aggregates form in the cellulose nanocrystal slurry.

10. The method as defined in claim 8 wherein the shear force is applied using sonication.

11. The method as defined in claim 10 wherein sonication is performed on ice for a time ranging from about 2 minutes to about 6 minutes.

12. The method as defined in claim 8 wherein the cellulose nanocrystal slurry includes cellulose nanocrystals including surface sulfonate groups, and wherein the method further comprises forming the cellulose nanocrystal slurry by exposing a dispersion of cellulose nanocrystals to acid hydrolysis using sulfuric acid.

13. The method as defined in claim 12 wherein after acid hydrolysis, the method further comprises exposing the cellulose nanocrystals to oxidants or esterification agents to obtain carboxylated cellulose nanocrystals.

14. A printing method, comprising:
introducing a plain paper into a thermal inkjet printer, the plain paper excluding an additive that produces a chemical interaction with a pigment in an ink composition that is printed thereon; and
from the thermal inkjet printer, jetting the ink composition onto the plain paper to form an image, the ink composition including:
cellulose nanocrystals present in an amount ranging from 0.5 wt % up to 3.5 wt %, based on a total weight of the thermal inkjet ink composition;
a sugar alcohol present in an amount ranging from 3 wt % up to about 8 wt % based on the total weight of the thermal inkjet ink composition;
an organic salt present in an amount ranging from about 0.05 wt % to about 0.5 wt % based on the total weight of the thermal inkjet ink composition;
the pigment;
a polar solvent; and
a balance of water.

15. The printing method as defined in claim 14, further comprising jetting the ink composition onto an enhanced paper to form an other image, the enhanced paper including an additive that produces a chemical interaction with the pigment in the ink composition, wherein color saturation of the image on the plain paper is within 0.1 of color saturation of the other image on the enhanced paper at any given % fill density.
